(19) United States
(12) Patent Application Publication
(10) Pub. No.: US 2025/0319610 A1
(43) Pub. Date: Oct. 16, 2025

(54) HAPTIC FEEDBACK APPARATUS AND CONTROL METHOD

(71) Applicant: CANON KABUSHIKI KAISHA, Tokyo (JP)

(72) Inventor: SHU IMAYA, Tokyo (JP)

(21) Appl. No.: 19/097,223

(22) Filed: Apr. 1, 2025

(30) Foreign Application Priority Data
Apr. 10, 2024 (JP) 2024-063537

(51) Int. Cl. B25J 13/02; G06F 3/01

(52) U.S. Cl. CPC B25J 13/025; G06F 3/013; G06F 3/016

(57) ABSTRACT

A haptic feedback apparatus that generates a tactile sensation on an operation unit that is capable of operating an operated unit, obtains haptic information representing the tactile sensation when the operated unit touches an object, detects an object in which a user operating the operation unit is interested from objects being within a predetermined range including an object which the operated unit is touching, and calculates a feedback amount for generating the tactile sensation in the operation unit based on information of an object in which the user is interested and the haptic information.

### BACKGROUND OF THE INVENTION

### Field of the Invention

The present invention relates to a technical field for performing a haptic feedback based on a degree of interest of a user.

### Description of the Related Art

Haptic feedback is a technology for transmitting a result and a state of an operation by applying a physical stimulus such as a vibration and/or a pressure to a hand or a finger of a user from an operation target object. The haptic feedback serves to confirm that an operation has been correctly performed by a user feeling as a vibration and/or a motion when the user operates the operation target object, or to enhance a usability and an accessibility of the user interface by providing a feedback through haptics to a user with a visual or auditory impairment as an important information source. The haptic feedback is also used by the user to appropriately perform an operation of a robotic arm or the like based on haptic information, or to improve an immersive feeling in a virtual space.

Japanese Patent Laid-Open No. 2015-215894 describes a technique of obtaining haptic information by a tactile sensor and performing haptic feedback when a user is interested in an object to which the tactile sensor is attached.

In Japanese Patent Laid-Open No. 2015-215894, a haptic feedback can be performed only when the user focuses on an object to which the tactile sensor is attached, and cannot be addressed when the user wants to obtain haptic information from an object to which the tactile sensor is not attached. Therefore, a technique capable of obtaining haptic information in association with an object in which the user is interested is desired.

### SUMMARY OF THE INVENTION

The present invention has been made in consideration of the aforementioned problems, and realizes techniques capable of performing a haptic feedback based on a degree of interest of a user.

In order to solve the aforementioned problems, the present invention provides a haptic feedback apparatus that generates a tactile sensation on an operation unit that is capable of operating an operated unit, comprising: an obtainment unit that obtains haptic information representing the tactile sensation when the operated unit touches an object; a detection unit that detects an object in which a user operating the operation unit is interested from objects being within a predetermined range including an object which the operated unit is touching; and a calculation unit that calculates a feedback amount for generating the tactile sensation in the operation unit based on information of an object in which the user is interested and the haptic information.

In order to solve the aforementioned problems, the present invention provides a control method of a haptic feedback apparatus that generates a tactile sensation in an operation unit that is capable of operating an operated unit, the method comprising: obtaining haptic information representing the tactile sensation when the operated unit touches an object; detecting an object in which a user operating the operation unit is interested from objects being within a predetermined range including an object which the operated unit is touching; and calculating a feedback amount for generating the tactile sensation in the operation unit based on information of an object in which the user is interested and the haptic information.

According to the present invention, the haptic feedback can be performed based on the degree of interest of the user.

Further features of the present invention will become apparent from the following description of exemplary embodiments (with reference to the attached drawings).

### BRIEF DESCRIPTION OF THE DRAWINGS

FIG. 1 is an external view schematically illustrating a haptic feedback apparatus according to a first embodiment.

FIG. 2 is a block diagram illustrating a configuration of the haptic feedback apparatus according to the first embodiment.

FIG. 3 is a flowchart illustrating haptic feedback processing according to the first embodiment.

FIG. 4 is a flowchart illustrating object-of-interest detection processing according to the first embodiment.

FIG. 5 is a block diagram illustrating a configuration of a haptic feedback apparatus including a gaze detection device according to the first embodiment.

FIG. 6 is a flowchart illustrating gaze detection processing according to the first embodiment.

FIGS. 7A and 7B are views illustrating a gaze detection method according to the first embodiment.

FIG. 8 is a view illustrating an eyeball image according to the first embodiment.

FIG. 9 is a flowchart illustrating object-of-interest detection processing based on gaze information according to the first embodiment.

FIGS. 10A-10C are views illustrating degree of interest calculation processing based on gaze information according to the first embodiment.

FIG. 11 is a flowchart illustrating haptic feedback amount calculation processing according to the first embodiment.

FIGS. 12A and 12B are external views schematically illustrating a haptic feedback apparatus according to a second embodiment.

FIG. 13 is a block diagram illustrating a configuration of a haptic feedback apparatus according to the second embodiment.

FIG. 14 is a flowchart illustrating a haptic feedback processing according to the second embodiment.

FIG. 15 is a flowchart illustrating haptic feedback amount calculation processing according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In the first embodiment, a haptic feedback apparatus that generates a tactile sensation in an operation unit that is capable of operating a robotic arm as an operated unit will be described.

### <Apparatus Configuration>

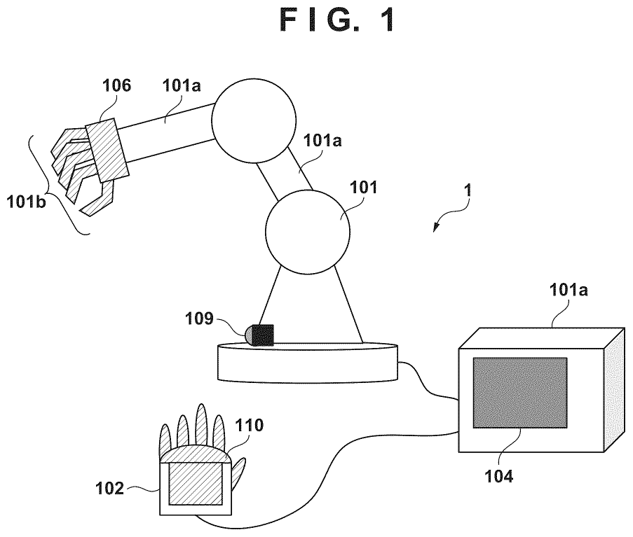

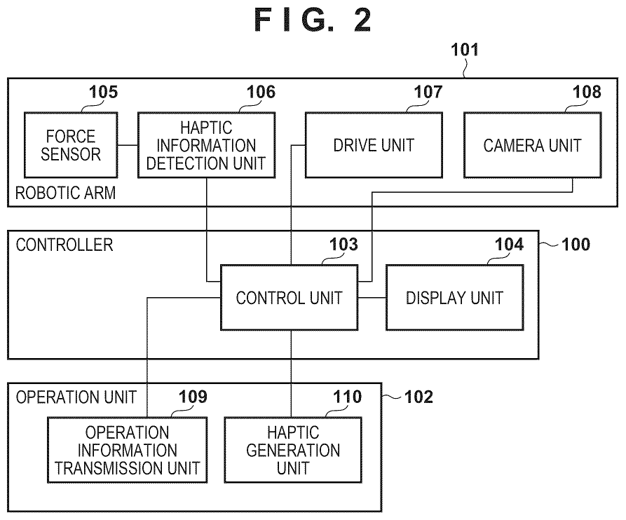

First, a configuration and functions of the haptic feedback apparatus according to the first embodiment will be described with reference to FIGS. 1 and 2.

FIG. 1 is an external view schematically illustrating the haptic feedback apparatus according to the first embodiment.

The haptic feedback apparatus 1 includes a controller 100, a robotic arm 101 and an operation unit 102.

The operation unit 102 is wearable on a hand of a user. When the user moves his/her hand or finger while wearing the operation unit 102, the arm portion 101a and the hand portion 101b of the robotic arm 101 can be moved in accordance with the movement. When the user moves his/her hand or finger while wearing the operation unit 102, the controller 100 receives the operation information corresponding to the user operation from the operation unit 102, and outputs the drive information corresponding to the operation information to the robotic arm 101. The robotic arm 101 drives the arm portion 101a and the hand portion 101b of the robotic arm 101 based on the drive information received from the controller 100.

A display unit 104 is provided in the controller 100, and displays GUI (Graphical User Interface of the controller 100). Further, the display unit 104 displays images of the hand portion 101b and the periphery of the hand portion 101b of the robotic arm 101 captured by the camera unit 108.

A haptic information detection unit 106 is provided on the hand portion 101b of the robotic arm 101. The haptic information detection unit 106 is capable of detecting haptic information applied to the hand portion 101b when the robotic arm 101 grips an object or the like. The haptic information detection unit 106 includes a force sensor capable of detecting force information as haptic information, and outputs the force information detected by the force sensor as haptic information from the robotic arm 101 to the controller 100.

The controller 100 calculates the haptic feedback amount from the haptic information obtained from the haptic information detection unit 106 and the information on the object in which the user is interested (the object-of-interest information), and outputs the haptic feedback amount to the haptic generation unit 110.

The haptic generation unit 110 is formed by a piezoelectric element or the like that applies a physical stimulus such as a vibration and/or a pressure to a hand or a finger of a user wearing the operation unit 102, and is provided on a hand or a finger of the operation unit 102. The haptic generation unit 110 generates a tactile sensation such as a vibration and/or a pressure corresponding to the haptic feedback amount received from the controller 100, and transmits the tactile sensation to the user via the operation unit 102.

FIG. 2 is a block diagram illustrating a hardware configuration of the haptic feedback apparatus according to the first embodiment.

The controller 100 includes a control unit 103 and the display unit 104. The control unit 103 includes a processor (CPU) that performs arithmetic processing and control processing of the haptic feedback apparatus 1, a volatile memory (ROM) that stores a program executed by the processor, a program read from the nonvolatile memory, and a work memory (RAM) that loads constants and variables for executing the program. The control unit 103 controls the respective components of the haptic feedback apparatus 1 by loading and executing a program stored in ROM into RAM.

Instead of the control unit 103 controlling the entire apparatus, a plurality of hardware may share processing to control the entire apparatus.

The display unit 104 includes a liquid crystal panel, an organic EL panel, or the like, and displays images and various information.

The robotic arm 101 includes a force sensor 105, a haptic information detection unit 106, a drive unit 107 and a camera unit 108.

The force sensor 105 detects force information applied to the hand portion 101b when the robotic arm 101 grips an object or the like.

The haptic information detection unit 106 outputs the haptic information detected by the force sensor 105 to the control unit 103.

The drive unit 107 drives the arm portion 101a and the hand portion 101b of the robotic arm 101 based on the drive information received from the control unit 103.

The camera unit 108 includes an image sensor and an A/D converter, converts an object image into an electric signal, and outputs image data including a digital signal to the control unit 103. The control unit 103 controls the display unit 104 to display an image of the periphery of the hand portion 101b and the hand portion 101b of the robotic arm 101 captured by the camera unit 108, and an image within a predetermined range including a portion which the hand portion 101b is touching when the hand portion 101b is holding an object.

The operation unit 102 includes an operation information transmission unit 109 and a haptic generation unit 110.

The operation information transmission unit 109 outputs operation information of the user wearing the operation unit 102 to the control unit 103. The control unit 103 outputs drive information corresponding to the operation information received from the operation information transmission unit 109 to the drive unit 107. The drive unit 107 drives the arm portion 101a and the hand portion 101b of the robotic arm 101 based on the drive information received from the control unit 103.

The haptic generation unit 110 applies a tactile sensation such as a vibration and/or a pressure to the operation unit 102 in accordance with the haptic feedback amount received from the control unit 103, and feeds the tactile sensation back to the user.

In FIGS. 1 and 2, the operation unit 102 and the control unit 103 are separately provided, but they may be incorporated in the same apparatus.

### <Control Processing>

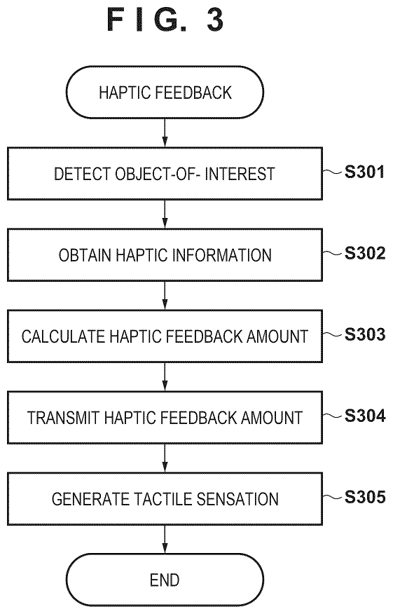

Next, haptic feedback processing based on the degree of interest of the user according to the first embodiment will be described with reference to FIG. 3.

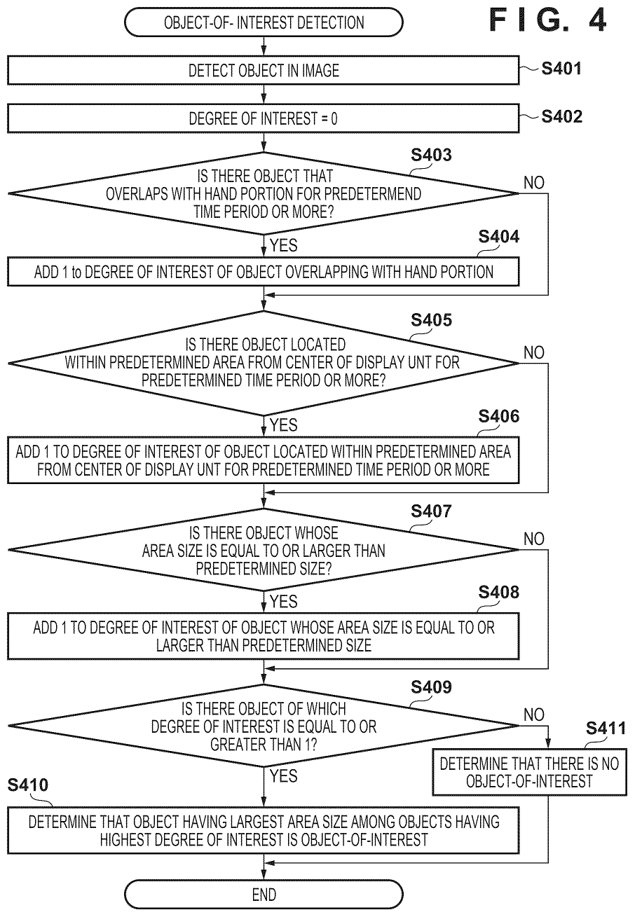

The processing of FIG. 3 is implemented by the control unit 103 of the controller 100 executing a program stored in ROM and controlling the display unit 104, the robotic arm 101 and the operation unit 102. The same applies to FIGS. 4, 6, 9 and 11 described later.

In step S301, the control unit 103 detects object-of-interest information. Details of the object-of-interest detection processing will be described later with reference to FIG. 4.

In step S302, the control unit 103 obtains haptic information from the haptic information detection unit 106.

In step S303, the control unit 103 calculates a haptic feedback amount for causing the haptic generation unit 110 to generate a tactile sensation from the object-of-interest information obtained in step S301 and the haptic information obtained in step S302.

In step S304, the control unit 103 transmits the haptic feedback amount calculated in step S003 to the haptic generation unit 110.

In step S305, the control unit 103 causes the haptic generation unit 110 to generate a tactile sensation corresponding to the haptic feedback amount.

### <Object-of-Interest Detection Processing>

Next, regarding the object-of-interest detecting processing in step S301 of FIG. 3, examples of processing using image information and processing using gaze information will be described.

### <Object-of-Interest Detection Processing Using Image Information>

Next, object-of-interest detection processing using image information will be described with reference to FIG. 4.

In step S401, the control unit 103 detects an object in an image captured by the camera unit 108 and displayed on the display unit 104, and discriminates an area of the object.

In step S402, the control unit 103 initializes the degree of interest to 0. The value of the degree of interest is an index indicating a degree of interest of the user.

In step S403, the control unit 103 determines whether or not there is an object that overlaps with the hand portion 101b (the haptic information detection unit 106) for a predetermined time period or more among the objects detected in step S401. When it is determined that there is an object that overlaps with the hand portion 101b for a predetermined time period or more, the processing proceeds to step S404, and otherwise, the processing skips the processing of step S404 and proceeds to step S405.

In step S404, the control unit 103 adds 1 to the degree of interest of the object overlapping with the hand portion 101b for a predetermined time period or more.

In step S405, the control unit 103 determines whether or not there is an object located within a predetermined area from a center of the display unit 104 for a predetermined time period or more among the objects detected in step S401. When it is determined that there is an object located within a predetermined range from the center of the image for a predetermined period of time or longer, the processing proceeds to step S406, and otherwise, the processing skips the processing of step S406 proceeds to step S407.

In step S406, the control unit 103 adds 1 to a value of the degree of interest of the object located within a predetermined area from the center of the image for a predetermined time period or more.

In step S407, the control unit 103 determines whether or not there is an object whose area size of the object detected in step S401 is equal to or larger than a predetermined size. When it is determined that there is an object whose area size is equal to or larger than the predetermined size, the processing proceeds to step S408, and otherwise, the processing skips the processing of step S408 and proceeds to step S409.

In step S408, the control unit 103 adds 1 to a value of the degree of interest of the object whose area size is equal to or larger than the predetermined size.

In step S409, the control unit 103 determines whether or not there is an object of which the value of the degree of interest is equal to or greater than 1. When it is determined that there is an object of which the value of the degree of interest is equal to or greater than 1, the processing proceeds to step S410, and otherwise, the processing proceeds to step S411.

In step S410, the control unit 103 determines that the object having the largest area size among the objects having the highest degree of interest is the object-of-interest.

In step S411, the control unit 103 determines that there is no object-of-interest.

### <Object-of-Interest Detection Processing Using Gaze Information>

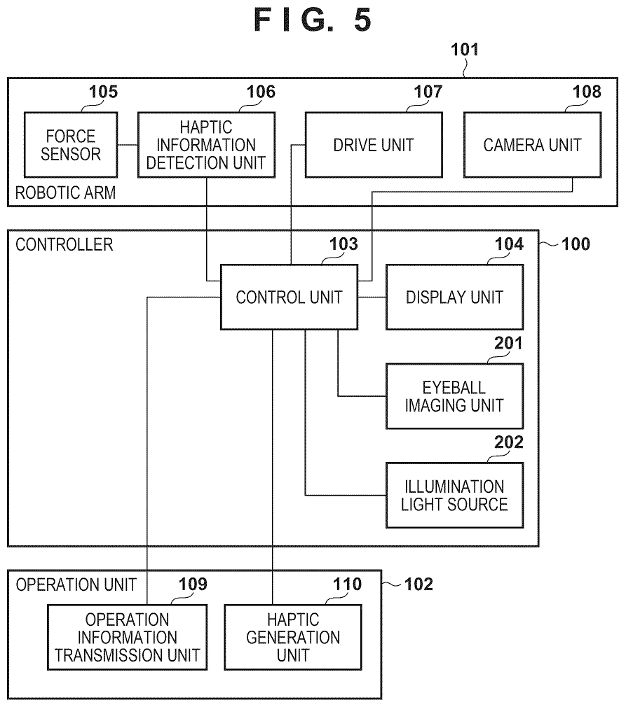

Next, object-of-interest detection processing using gaze information will be described with reference to FIGS. 5 to 8.

FIG. 5 is a block diagram illustrating a hardware configuration of a haptic feedback apparatus including a gaze detection device.

The controller 100 is provided with an eyeball imaging unit 201 and an illumination light source 202 as devices for detecting the gaze of the user.

The eyeball imaging unit 201 captures an eyeball image of the user and outputs the captured image to the control unit 103. The control unit 103 performs a gaze detection of the user based on the eyeball image.

The illumination light source 202 emits infrared light to the eyeball of an observer so that the eyeball imaging unit 201 can capture an image of an appropriate brightness for a gaze detection.

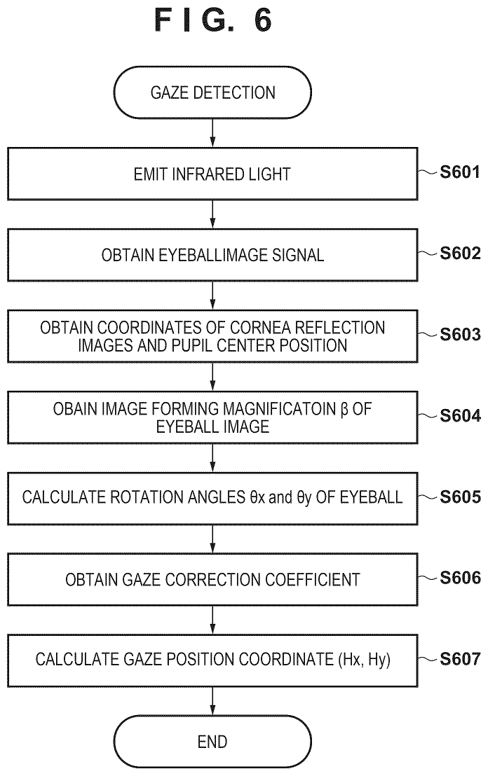

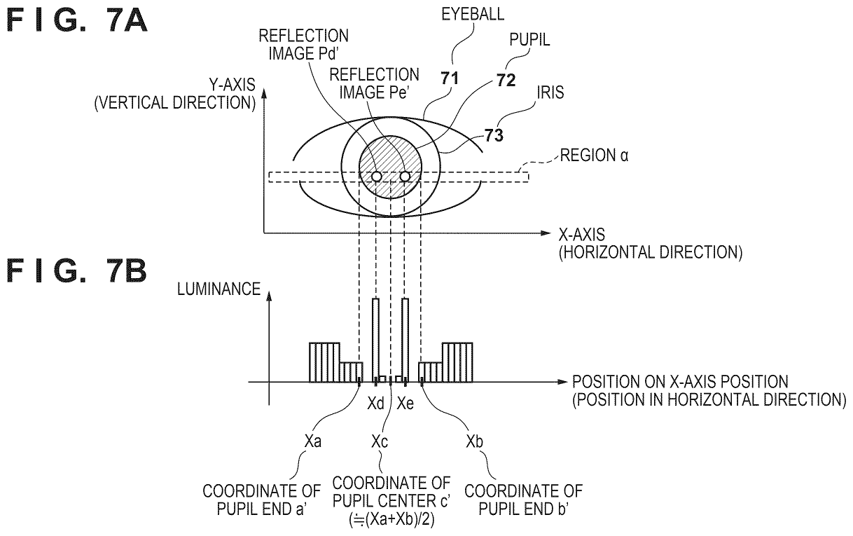

Next, gaze detection processing will be described with reference to FIGS. 6 and 7.

FIG. 6 is a flowchart illustrating gaze detection processing. FIGS. 7A and 7B are views illustrating a gaze detection method.

In step S601, the control unit 103 emits infrared light toward the eyeball 71 of the observer by the illumination light source 202. The eyeball image of the observer illuminated by the infrared light is formed on the eyeball imaging unit 201. The eyeball imaging unit 201 generates an eyeball image signal obtained by converting an eyeball image formed on the eyeball imaging unit 201 into an electric signal.

In step S602, the control unit 103 obtains the eyeball image signal from the eyeball imaging unit 201.

In step S603, the control unit 103 obtains coordinates of points corresponding to cornea reflection images Pd and Pe and a pupil center c of the illumination light source 202 shown in FIG. 7A from the information of the eyeball image signal obtained in step S602.

FIG. 7A illustrates cornea reflection images obtained from the eyeball images. FIG. 7B illustrates luminance information obtained from the area a of the eyeball images of FIG. 7A.

The infrared light emitted from the illumination light source 202 illuminates the cornea of the eyeball 71 of the observer, and the cornea reflection images Pd and Pe formed by a part of the infrared light reflected on the surface of the cornea form an image on the eyeball imaging unit 201 (points Pd′ and Pe′ in FIG. 7A). Similarly, the light flux from end portions a and b of the pupil 72 forms an image on the eyeball imaging unit 201.

In FIGS. 7A and 7B, the horizontal direction is an X-axis, and the vertical direction is a Y-axis, and the coordinates of the images Pd′ and Pe′ formed by the cornea reflection image of the illumination light source 202 in the X-axis direction (horizontal direction) are Xd and Xe. In addition, in FIGS. 7A and 7B, the coordinate of the X-axis direction of the image a′, b′ formed by the light flux from the end portion of the pupil 72 is taken as Xa and Xb.

In the luminance information in FIG. 7B, an extremely strong luminance is obtained at the position Xd and Xe corresponding to the images Pd′ and Pe′ on which the cornea reflection image of the illumination light source 202 forms an image. The area between the coordinate Xa and Xb, which corresponds to the area of the pupil 72, results in an extremely low-level luminance except for the position of Xd and Xe. On the other hand, in a region having a value of the X coordinate lower than Xa and a region having a value of the X coordinate higher than Xb corresponding to the region of the iris 73 outside the pupil 72, an intermediate value of the two luminance levels is obtained. From the variation information of the luminance level with respect to the X coordinate position, the X coordinate Xd and Xe of the images Pd′ and Pe′ formed by the cornea reflection image of the illumination light source 202 and the X coordinate Xa and Xb of the image a′, b′ of the pupil end can be obtained. In addition, when the Ox of the optical axis of the eyeball 14 with respect to the optical axis of the eyeball imaging unit 201 is small, the coordinate Xc of a portion (referred to as a c′) corresponding to the pupil center c forming an image on the eyeball imaging unit 201 can be expressed as Xc≐(Xa+Xb)/2. In this way, it is possible to estimate the X coordinate of c′ corresponding to the pupil center forming an image on the eyeball imaging unit 201 and the coordinate of the cornea reflection images Pd′ and Pe′ of the eyeball imaging unit 201.

In step S604, the control unit 103 calculates the image forming magnification B of the eyeball image is a magnification determined by the position of the eyeball 71 with respect to the optical system of the eyeball imaging unit 201, and can be obtained substantially as a function of the distance (Xd−Xe) of the cornea reflection images Pd′ and Pe′.

In step S605, since the X coordinate of the midpoint of the cornea reflection images Pd′ and Pe′ substantially coincides with the X coordinate of the center of curvature O of the cornea 74, the control unit 103 can obtain the Ox in Z-X plane of the optical axis of the eyeball 71 from Equation 1, assuming that the normal distance between the center of curvature O of the cornea 74 and the center c of the pupil 72 is Oc.

$$B * Oc * SIN θ x \{ ( Xd + Xe ) / 2 \} - Xc \qquad ( Equation 1 )$$

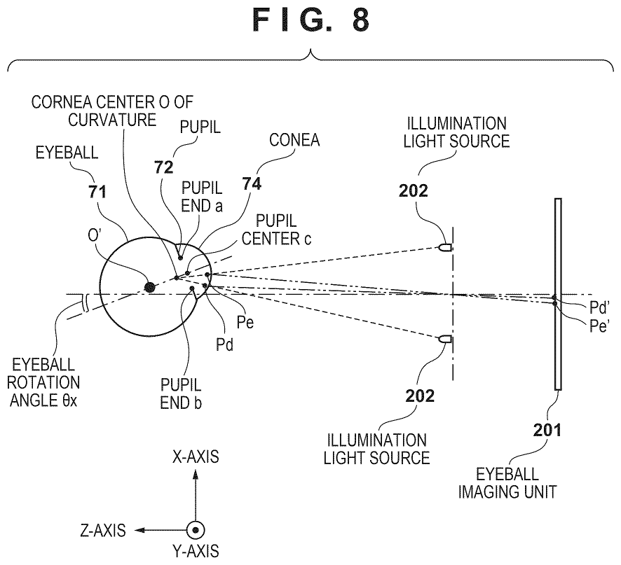

FIG. 8 shows an example of calculating the rotation angle θx when the eyeball of the observer rotates in a plane perpendicular to the Y-axis, the same applies to the calculation method of the rotation angle θy when the eyeball of the observer rotates in a plane perpendicular to the X-axis.

In step S606, the control unit 103 reads gaze correction coefficients Ax, Bx, Ay, By for correcting individual differences in a gaze of the user from a ROM. The gaze correction coefficients Ax, Bx, Ay, By represent an offset amount in the x-direction, a sensitivity coefficient for the rotation angle, an offset amount in the y-direction, and a sensitivity coefficient for the rotation angle. These values are obtained by performing a calibration operation and stored in the ROM.

In step S607, the control unit 103 obtains the gaze position (gaze position) of the user on the display unit 104 using θx and θy. The gaze position can be calculated from Equation 2, assuming that the coordinates corresponding to the center c of the pupil 72 on the display unit 104 are the left eye, the right eye (Hx_L, Hy_L), and (Hx_R, Hy_R), respectively.

$$Hx\_L = m * ( Ax * θ x + Bx ) * nLx \qquad ( Equation 2 )$$

$$Hx\_R = m * ( Ax * θ x + Bx ) * nRx$$

$$Hy\_L = m * ( Ay * θ y + By ) * nLy$$

$$Hy\_R = m * ( Ay * θ y + By ) * nRy$$

The coefficient m is a constant determined by the configuration of the optical system of the gaze detection device, and is a conversion coefficient for converting the rotation angles θx and θy into position coordinates corresponding to the center c of the pupil 72 in the display unit 104. The coefficient m and the correction coefficient (nLx, nLy, nRx, nRy) for correcting the reliability of the left and right eyes when determining the gaze position are determined in advance.

Then, the control unit 103 calculates the total gaze position (Hx, Hy) from Hx_L, Hx_R, Hy_L, and Hy_R.

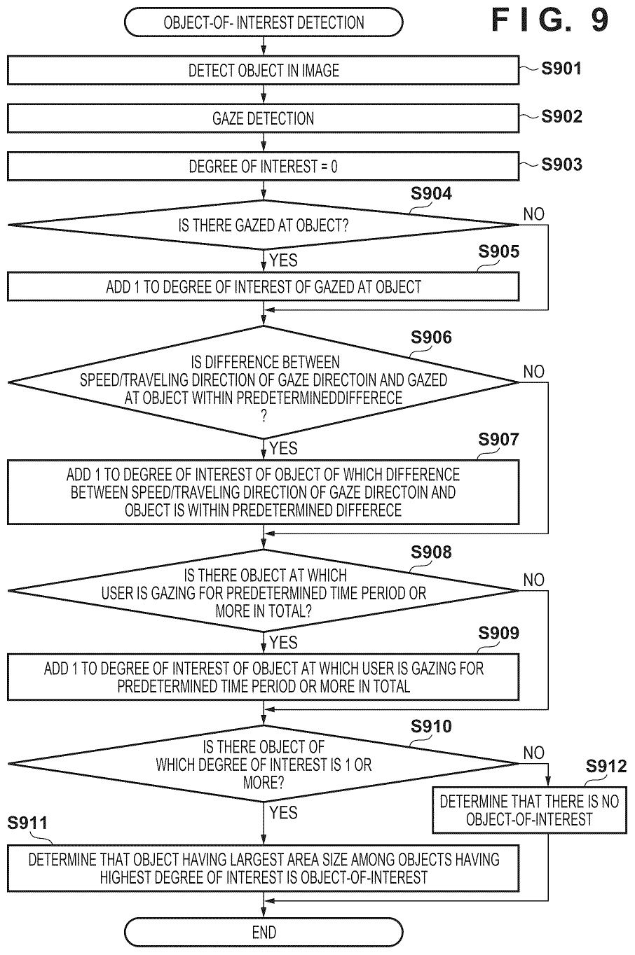

Next, the object-of-interest detection processing using the gaze information detected as described with reference to FIGS. 6 to 8 will be described with reference to FIG. 9.

FIG. 9 is a flowchart illustrating the object-of-interest detection processing using gaze information.

In step S901, the control unit 103 detects object(s) from images displayed on the display unit 104, and determines regions of each object.

In step S902, the control unit 103 detects the gaze direction of the user and determines the position at which the user is gazing at the display unit 104.

In step S903, the control unit 103 initializes the value of the degree of interest to 0.

In step S904, the control unit 103 determines whether or not there is an object (gazed at object) at which the user is continuously gazing for a predetermined time period or more from the present time among the objects detected in step S901. When it is determined that there is a gazed at object, the processing proceeds to step S905, and otherwise, the processing skips the processing of step S905 and proceeds to step S906.

In step S905, the control unit 103 adds 1 to the value of the degree of interest of the gazed at object.

In step S906, the control unit 103 compares a speed and/or a traveling direction of the gaze direction of the user with the speed and/or the traveling direction of the gazed at object, respectively and determines whether or not differences between the speed and/or the traveling direction of the gaze direction of the user and the gazed at object fall within a predetermined difference. When it is determined that the differences between the speed and/or the traveling direction of the gaze direction of the user and the gazed fall within the predetermined difference, the processing proceeds to step S907, and otherwise, the processing skips the processing of step S907 and proceeds to step S908.

In step S907, the control unit 103 adds 1 to the values of the degree of interest of the gazed at object.

In step S908, the control unit 103 determines whether or not there is the gazed at object in the gaze direction for the predetermined time period or more in total while the gazed at object is being detected, and determines whether or not there is an object at which the user is gazing for a long time. When it is determined that there is an object for which the user is gazing for a long time, the processing proceeds to step S909, and otherwise, the processing skips the processing of step S909 and proceeds to step S910.

In step S909, the control unit 103 adds 1 to the value of the degree of interest of the object at which the user is gazing for a long time.

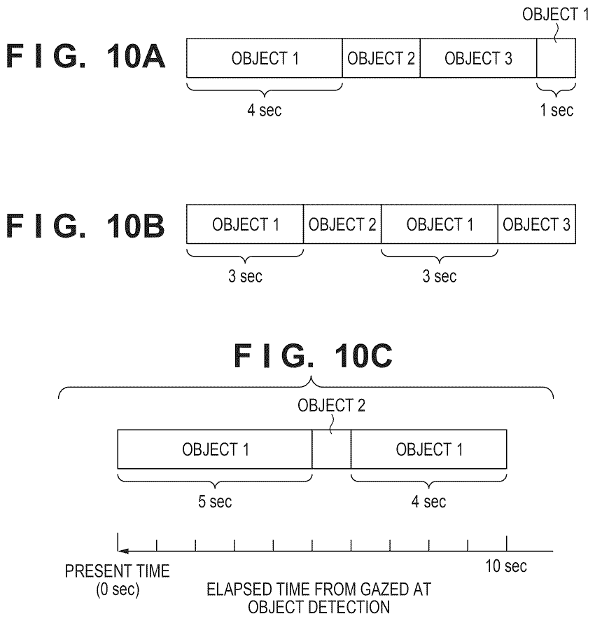

Here, the determination processing of steps S904 and S908 will be described with reference to FIGS. 10A-10C.

FIGS. 10A-10C illustrate temporal transitions of an object in a gaze direction at which the user is gazing. In FIGS. 10A-10C, the detection period of the gazed at object is 10 sec from the present time, but the present invention is not limited thereto, and a different period may be set.

Hereinafter, the determination threshold of step S904 will be described as 4 sec, and the determination threshold of step S908 will be described as 6 sec.

In FIG. 10A, since the user is gazing at the object 1 for 4 sec from the present time and the determination condition of step S904 is satisfied, 1 is added to the value of the degree of interest of the object 1. Further, since no object is gazed for more than 6 sec, there is no object of which the degree of interest is added in step S908.

In FIG. 10B, since there is no object at which the user is gazing for 4 sec or more from the present time, there is no object which satisfies the determination condition of step S904 and the degree of interest is added. In addition, since the user is gazing at the object 1 for 6 sec in total during the determination period, 1 is added to the value of the degree of interest of the object 1 in step S908.

In FIG. 10C, since the user is gazing at the object 1 for 5 sec from the present time and the determination condition of step S904 is satisfied, 1 is added to the value of the degree of interest of the object 1. In addition, since the user is gazing at the object 1 for 9 sec in total during the determination period, 1 is added to the value of the degree of interest of the object 1 in step S908.

In step S910, the control unit 103 determines whether or not there is an object of which the degree of interest is 1 or more. When it is determined that there is an object of which the degree of interest is 1 or more, the processing proceeds to step S911, and otherwise, the processing proceeds to step S912.

In step S911, the control unit 103 determines that the object having the largest area size among the objects having the highest degree of interest is the object-of-interest.

In step S912, the control unit 103 determines that there is no object-of-interest.

### <Haptic Feedback Amount Calculation Processing>

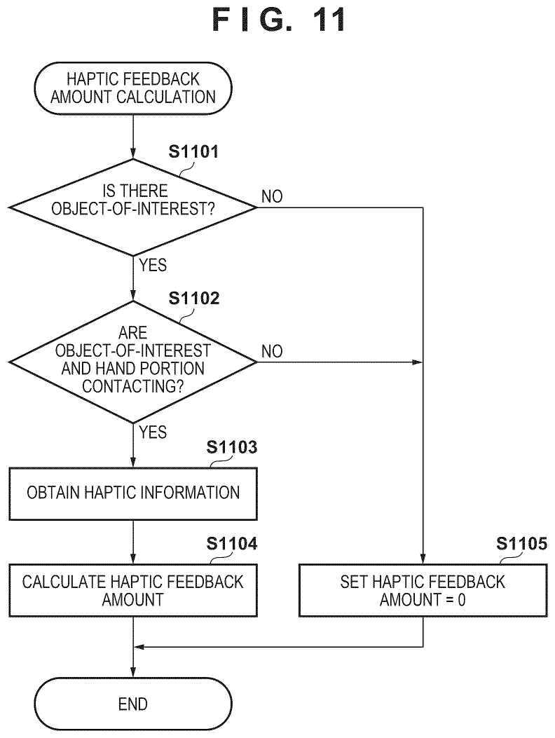

Next, with reference to FIG. 11, processing of calculating the haptic feedback amount in step S303 of FIG. 3 will be described.

The processing of FIG. 11 is started when the haptic information is detected in step S302 of FIG. 3 and the object-of-interest determination processing is performed in FIG. 4 or FIG. 9.

In step S1101, the control unit 103 determines whether or not there is an object-of-interest. When it is determined that there is an object-of-interest, the processing proceeds to step S1102, and otherwise, the processing proceeds to step S1105.

In step S1102, the control unit 103 determines whether or not the object-of-interest and the hand portion 101b are contacting each other from the images displayed on the display unit 104. When it is determined that the object-of-interest and the hand portion 101b are contacting each other, the processing proceeds to step S1103, and otherwise, the processing proceeds to step S1105.

In step S1105, the control unit 103 sets the haptic feedback amount to 0 and does not execute the haptic feedback.

In step S1103, the control unit 103 obtains haptic information from the haptic information detection unit 106.

In step S1104, the control unit 103 calculates the haptic feedback amount based on the degree of interest of the object-of-interest. Assuming that the haptic feedback amount is H_fb, the haptic information is H_in, and the degree of interest is Int, the haptic feedback amount is calculated as Equation 3.

$$H\_fb = H\_in ( 0.6 + 0.2 * Int ) \qquad ( Equation 3 )$$

As described above, according to the first embodiment, a suitable haptic feedback can be implemented by calculating the haptic feedback amount based on the degree of interest of the user with respect to the object in the real space.

### Second Embodiment

In the first embodiment, an example has been described in which the haptic feedback is performed based on the degree of interest of the user with respect to the object in the real space. In the second embodiment, an example will be described in which a haptic feedback is performed based on a degree of interest of a user with respect to an object existing in a virtual space.

In the second embodiment, a haptic feedback apparatus that generates a tactile sensation in an operation unit that is capable of operating an avatar in a virtual space as an operated unit will be described.

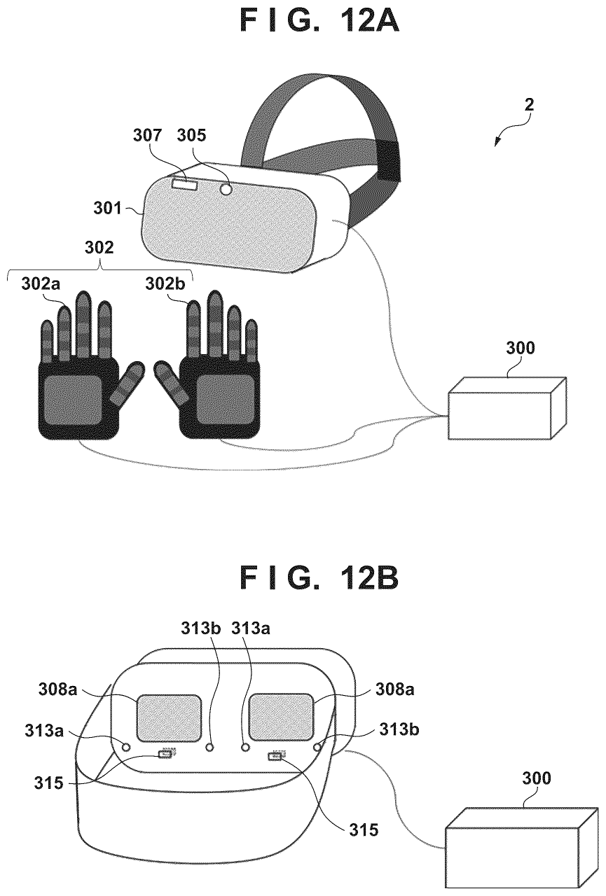

FIGS. 12A and 12B are external views schematically illustrating the haptic feedback apparatus according to the second embodiment. FIG. 12A is a front perspective view of the haptic feedback apparatus according to the second embodiment. FIG. 12B is a rear perspective view of the haptic feedback apparatus according to the second embodiment.

The haptic feedback apparatus 2 of the second embodiment includes a controller 300, a goggle-type device 301 which is wearable on a head of a user, and an operation unit 302. The goggle-type device 301 includes a gaze detection device that detects a gaze direction for each of the left and right eyeballs. The left and right eyes are also referred to as binocular eyes.

The goggle-type device 301 generates and visually displays an object such as an avatar in the virtual space.

The operation unit 302 has left and right operation units 302a and 302b that are wearable on left and right hands of the user, and is used to operate the avatar in the virtual space that is viewed by the goggle-type device 301.

The goggle-type device 301 is provided with an imaging unit 305 and a photometry unit 307.

The goggle-type device 301 is provided with illumination light sources 313a and 313b for each of the left and right eyeballs. The illumination light sources 313a and 313b are light sources such as a light-emitting diode that emits infrared light that is insensitive to the user, and each light source illuminates the left and right eyeballs of the user. A part of the illumination light reflected by the eyeball converges on the eyeball imaging unit 315 for each of the left and right eyeballs.

In addition, the goggle-type device 301 is provided with display units 308a and 308b for each of the left and right eyeballs.

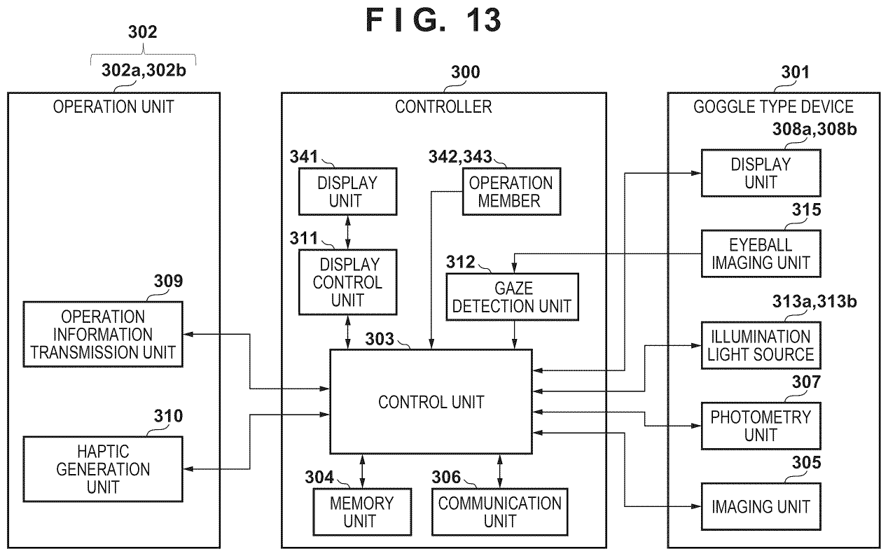

FIG. 13 is a block diagram illustrating a hardware configuration of the haptic feedback apparatus according to the second embodiment.

The controller 300 includes a control unit 103, a memory unit 304, a communication unit 306, a display control unit 311, a gaze detection unit 312, a display unit 341, and operation members 342 and 343.

The control unit 303 includes a processor (CPU) that performs arithmetic processing and control processing of the haptic feedback apparatus 2, a volatile memory (ROM) that stores a program executed by the processor, a program read from the nonvolatile memory, and a working memory (RAM) that loads constants and variables for executing the program. The control unit 303 controls each component of the haptic feedback apparatus 2 by loading and executing the program stored in ROM into RAM.

Instead of the control unit 303 controlling the entire apparatus, a plurality of hardware may share processing to control the entire apparatus.

The memory unit 304 stores image signal from the eyeball imaging unit 315, gaze correction data for correcting individual differences in a gaze, and degree-of-interest calculation information set for each object.

The communication unit 306 includes an interface that enables communication with the Internet or an external apparatus. The communication method may be wired or wireless.

The gaze detection unit 312 obtains an eyeball image from the eyeball imaging unit 315, and outputs a result of the gaze detection to the control unit 303. The control unit 303 detects the gaze direction of the user in accordance with the algorithm described with reference to FIG. 6.

The display control unit 311 controls the display unit 341 based on a display control signal from the control unit 303. The display unit 341 includes a liquid crystal panel, an organic EL panel, or the like, and displays images and various information.

The operation members 342 and 343 accept a user operation and transmits operation information corresponding to the user operation to the controller 300.

The goggle-type device 301 includes display units 308a and 308b, an eyeball imaging unit 315, illumination light sources 313a and 313b, an imaging unit 305, and a photometry unit 307.

The display units 308a and 308b display an avatar in the virtual space for each of the left and right eyeballs.

The eyeball imaging unit 315 captures an eyeball image of the user and outputs the captured image to the control unit 303.

The illumination light sources 313a and 313b emit infrared light to the eyeball of the observer. Thus, the eyeball imaging unit 315 can capture an image of an appropriate brightness for a gaze detection.

The imaging unit 305 captures an image of the subject field which is viewable by the user, and outputs the generated imaging signal to the control unit 303. The photometry unit 307, as a photometric sensor, amplifies the luminance signal output corresponding to the luminance of the subject field based on the imaging signal generated by the imaging unit 305, performs a logarithmic compression and an A/D conversion, and outputs the result to the control unit 303 as the subject field luminance information.

The goggle-type device 301 may be a non-transmission type such as VR (virtual reality) or a transmission type such as AR (augmented reality).

In FIGS. 12 and 13, the goggle-type device 301 and the control unit 303 are separately provided, but they may be incorporated in the same apparatus.

The operation units 302a and 302b include an operation-information transmission unit 309 and a haptic generation unit 310.

The operation information transmission unit 309 outputs the operation information of the user wearing the operation units 302a and 302b to the control unit 303. The control unit 303 reproduces a movement of the avatar in the virtual space in accordance with the operation information received from the operation information transmission unit 309.

The haptic generation unit 310 applies a tactile sensation such as vibrations or pressures to the operation units 302a and 302b in accordance with the haptic feedback amount received from the control unit 303, and feeds the tactile sensation back to the user.

### <Haptic Feedback Processing>

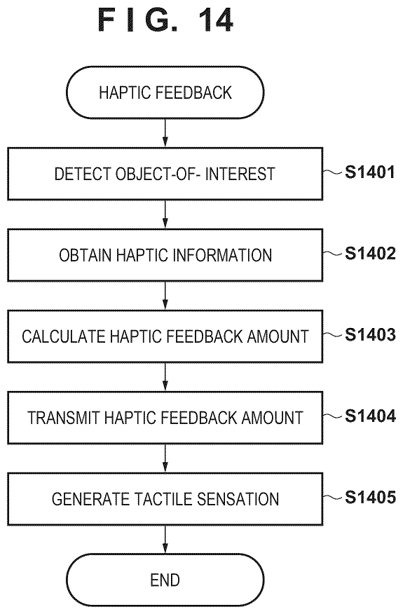

Next, haptic feedback processing according to the second embodiment will be described with reference to FIG. 14.

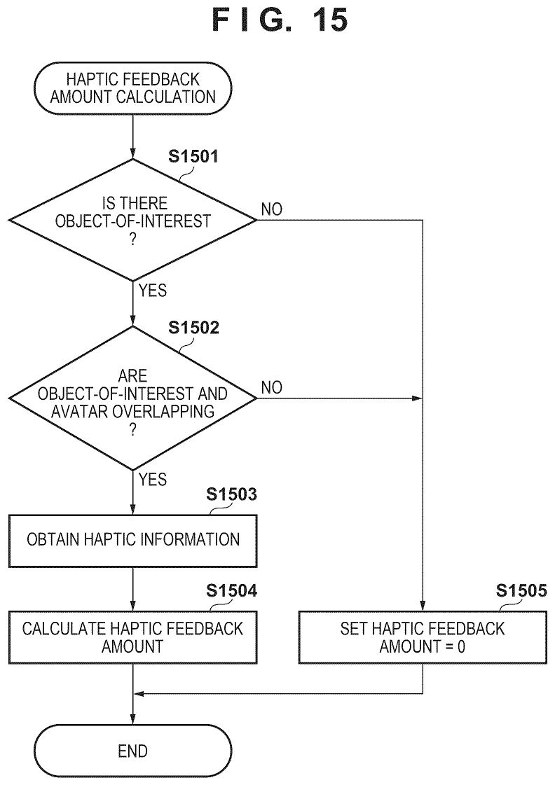

The processing of FIG. 14 is implemented by the control unit 303 of the controller 300 executing a program stored in a ROM and controlling the goggle-type device 301 and the operation units 302a and 302b. The same applies to FIG. 15 described later.

In step S1401, the control unit 303 performs a detection of the object-of-interest using images displayed on the display unit 308. The object-of-interest detection processing according to the first embodiment has been be described with reference to FIGS. 4 to 10.

In step S1402, the control unit 303 calculates the haptic information based on the object-of-interest detected in step S1401 and the movement of the avatar operated by the operation units 302a and 302b.

In step S1403, the control unit 303 calculates the haptic feedback amount based on the object-of-interest information and the haptic information obtained in step S1402.

In step S1404, the control unit 303 transmits the haptic feedback amount calculated in step S1403 to the haptic generation unit 310.

In step S1405, the control unit 303 causes the haptic generation unit 310 to generate a tactile sensation corresponding to the haptic feedback amount.

FIG. 15 is a flowchart illustrating the haptic feedback calculation processing of steps S1402 and S1403 of FIG. 14.

In step S1501, the control unit 303 determines whether or not there is an object-of-interest, and when it is determined that there is an object-of-interest, the processing proceeds to step S1502, and otherwise, the processing proceeds to step S1501.

In step S1502, the control unit 303 determines whether or not the object-of-interest and the avatar being operated by the operation units 302a and 302b overlap each other. The control unit 303 determines whether or not the object-of-interest and the avatar being operated by the operation units 302a and 302b overlap using position information and shape information of the object-of-interest to be used in generating images in the virtual space and position information and shape information of the avatar being operated by the operation units 302a and 302b. When it is determined that the object-of-interest and the avatar overlap each other, the processing proceeds to step S1503, and otherwise, the processing proceeds to step S1505.

In step S1505, the control unit 103 sets the haptic feedback amount to 0 and does not execute the haptic feedback.

In step S1503, the control unit 303 calculates the haptic information based on the physical calculation parameters of the object-of-interest and the avatar. The control unit 303 calculates a force applied to each part of the avatar by using a speed, a stiffness parameter, and the like of the object-of-interest and the avatar.

In step S1504, the control unit 303 calculates the haptic feedback amount based on the degree of interest of the object-of-interest. The haptic feedback amount generated as described above are transmitted to the haptic generation unit 310 in step S1404 of FIG. 14, and the haptic feedback is performed to the user by the haptic generation unit 310 generating the tactile sensation in step S1405.

As described above, according to the second embodiment, a suitable haptic feedback can be implemented by calculating the haptic feedback amount based on the degree of interest of the user with respect to the object existing in the virtual space.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-063537, filed Apr. 10, 2024 which is hereby incorporated by reference herein in its entirety.

What is claimed is:

1. A haptic feedback apparatus that generates a tactile sensation on an operation unit that is capable of operating an operated unit, comprising:
an obtainment unit that obtains haptic information representing the tactile sensation when the operated unit touches an object;
a detection unit that detects an object in which a user operating the operation unit is interested from objects being within a predetermined range including an object which the operated unit is touching; and
a calculation unit that calculates a feedback amount for generating the tactile sensation in the operation unit based on information of an object in which the user is interested and the haptic information.

2. The apparatus according to claim 1, further comprising a setting unit that sets a degree of interest of an object being within the predetermined range.

3. The apparatus according to claim 2, further comprising a display unit that displays images within the predetermined range,
wherein the setting unit sets the degree of interest using the images displayed on the display unit.

4. The apparatus according to claim 3, wherein the setting unit sets a degree of interest of an object overlapping with the operated unit for a predetermined time period or more, a degree of interest of an object being within the predetermined range, and a degree of interest of an object having a predetermined size or more among the objects to a value higher than a degree of interest of another object.

5. The apparatus according to claim 4, wherein the calculation unit calculates the feedback amount using the object information of the object having the largest size among the objects having the highest degree of interest.

6. The apparatus according to claim 2, wherein when there is no object of which the degree of interest is set, the calculation unit does not calculate the feedback amount.

7. The apparatus according to claim 2, further comprising a display unit that displays an image within the predetermined range, a gaze detection unit that detects a gaze direction of the user,
wherein the setting units sets the degree of interest based on the image displayed on the display unit and the gaze of the user.

8. The apparatus according to claim 7, wherein the setting unit sets the degree of interest of the object being in the gaze direction to a value higher than the degree of interest of another object.

9. The apparatus according to claim 8, wherein the setting unit sets a degree of interest of an object being in the gaze direction for a predetermined time period or more, a degree of interest of an object having differences between a speed and/or a traveling direction of the gaze direction and the object falling within a predetermined difference, and a degree of interest of an object being in the gaze direction for a predetermined time period or more in total to a value that is higher than a degree of interest of another object.

10. The apparatus according to claim 9, wherein the calculation unit calculates the feedback amount using the object information of the object having the largest size among the objects having the highest degree of interest.

11. The apparatus according to claim 7, wherein when there is no object of which the degree of interest is set, the calculation unit does not calculate the feedback amount.

12. The apparatus according to claim 1, wherein the operation unit includes a haptic generation unit configured to apply the tactile sensation based on the feedback amount.

13. The apparatus according to claim 1, wherein the operated unit is a robotic arm, and the haptic information is generated based on information detected by a sensor provided in the robotic arm.

14. The apparatus according to claim 1, wherein the operated unit is an avatar in a virtual space, and the haptic information is generated based on the object in the virtual space and position information of the avatar operated by the operation unit.

15. A control method of a haptic feedback apparatus that generates a tactile sensation in an operation unit that is capable of operating an operated unit, the method comprising:
obtaining haptic information representing the tactile sensation when the operated unit touches an object;
detecting an object in which a user operating the operation unit is interested from objects being within a predetermined range including an object which the operated unit is touching; and
calculating a feedback amount for generating the tactile sensation in the operation unit based on information of an object in which the user is interested and the haptic information.

16. A non-transitory computer-readable storage medium storing a program for causing a computer to function as a haptic feedback apparatus that generates a tactile sensation on an operation unit that is capable of operating an operated unit, comprising:
an obtainment unit that obtains haptic information representing the tactile sensation when the operated unit touches an object;
a detection unit that detects an object in which a user operating the operation unit is interested from objects being within a predetermined range including an object which the operated unit is touching; and
a calculation unit that calculates a feedback amount for generating the tactile sensation in the operation unit based on information of an object in which the user is interested and the haptic information.
